(19) United States
(12) Patent Application Publication
(10) Pub. No.: US 2017/0015328 A1
(43) Pub. Date: Jan. 19, 2017

(54) DRIVE ASSIST APPARATUS AND METHOD

(71) Applicant: TOYOTA JIDOSHA KABUSHIKI KAISHA, Toyota-shi (JP)

(72) Inventor: Haruki OGURI, Toyota-shi (JP)

(73) Assignee: TOYOTA JIDOSHA KABUSHIKI KAISHA, Toyota-shi (JP)

(21) Appl. No.: 15/117,802

(22) PCT Filed: Jan. 30, 2015
(86) PCT No.: PCT/IB2015/000101

§ 371 Date: Aug. 10, 2016

(30) Foreign Application Priority Data
Feb. 14, 2014 (JP) 2014-026592

(51) Int. Cl. B60W 30/18; B60W 50/00; B60W 50/14; B60W 20/00

(52) U.S. Cl. CPC B60W 30/18127; B60W 20/00; B60W 50/0097; B60W 50/14; B60W 2520/10; B60W 2550/22

(57) ABSTRACT

A driving assist apparatus includes: a regenerative braking force calculation unit for calculating an index by which a vehicle can be decelerated only by a regeneration operation of the electric motor; a display unit for displaying an indication that the vehicle can be decelerated only by the regeneration operation of the electric motor in a recognizable manner to driver of the vehicle; a prediction unit for predicting a target position at which the vehicle is decelerated to a target speed; and a timing calculation unit for calculating a timing at which the display unit displays the indication that the vehicle can be decelerated only by the regeneration operation, according to a distance or time required until a speed of the vehicle becomes the target speed by a deceleration performed based on the index, a distance or time required until the driver starts a deceleration operation, and the predicted target position.

### BACKGROUND OF THE INVENTION

1. Field of the Invention

The present invention relates to a driving assist apparatus and a driving assist method.

2. Description of Related Art

A hybrid vehicle using a combination of an engine and an electric motor as a driving source, an electric vehicle using only an electric motor as a driving source, and so on are known. Such a hybrid vehicle and so on can recover a portion of kinetic energy of the vehicle as electric energy by a regeneration operation of the electric motor when the vehicle is decelerated. Therefore, in order to improve energy efficiency of the vehicle, a technique of assisting.driving operation has been proposed such that more electric energy can be recovered. One example of such a technique is described in Japanese Patent Application Publication No. 2008-114791 (JP 2008-114791).

The technique described in JP 2008-114791 is a technique related to a display apparatus for a hybrid vehicle. The hybrid vehicle includes, as its driving source, an engine, an electric motor (an rotating machine) operating with electric power supplied from a battery (an power storage mechanism), and a mechanical brake (an brake mechanism). Further, the hybrid vehicle includes a display apparatus, which includes a calculation unit for calculating an index by which the vehicle can be decelerated by the electric motor without actuating the brake, and a display unit for displaying the calculated index to notify the driver of the index.

According to the technique described in JP 2008-114791 and so on, use of the mechanical brake is reduced by a deceleration driving operation that is performed in accordance with the index that is displayed on the display apparatus. On the other hand, more electric energy is recovered by using more regenerative braking that is achieved by the electric motor. However, since a deceleration that is achieved by the regenerative braking of the electric motor may not be very large, if some delay occurs during the deceleration operation, a deceleration of the vehicle exceeding the deceleration that is achieved by the regenerative braking of the electric motor is required, and naturally the mechanical brake is used in combination. In other words, the electric power regenerated from the electric motor is reduced by an amount that corresponds to the energy consumed by the mechanical brake.

### SUMMARY OF THE INVENTION

Therefore, there is provided a driving assist apparatus and a driving assist method, which can provide assist information by which more electric energy can be regenerated when a vehicle is decelerated.

According to a first aspect of the invention, there is provided a driving assist apparatus of performing driving assist for a vehicle which includes an electric motor for charging electric power regenerated by being mechanically driven by wheels to a power storage unit, the driving assist apparatus including: an index calculation unit configured to calculate an index by which the vehicle can be decelerated only by a regeneration operation of the electric motor; a display unit configured to display an indication that the vehicle can be decelerated only by the regeneration operation of the electric motor in a recognizable manner to a driver of the vehicle; a prediction unit configured to predict a target position at which the vehicle is decelerated to a target speed; and a calculation unit configured to calculate a timing at which the display unit displays the indication that the vehicle can be decelerated only by the regeneration operation, according to a distance or time required until a speed of the vehicle becomes the target speed by a deceleration that is performed based on the index, a distance or time required until the driver starts a deceleration operation, and the predicted target position.

According to a second aspect of the invention, there is provided a driving assist method of performing driving assist for a vehicle which includes an electric motor for charging electric power regenerated by being mechanically driven by wheels to a power storage unit, the driving assist method including: calculating an index by which the vehicle can be decelerated only by a regeneration operation of the electric motor; displaying, on a display unit, an indication that the vehicle can be decelerated only by the regeneration operation of the electric motor in a recognizable manner to a driver of the vehicle; predicting a target position at which the vehicle is decelerated to a target speed; and calculating a timing at which the display unit displays the indication that the vehicle can be decelerated only by the regeneration operation, according to a distance or time required until a speed of the vehicle becomes the target speed by a deceleration that is performed based on the index, a distance or time required until the driver starts a deceleration operation, and the predicted target position.

According to the above aspects, the display unit displays the indication that the vehicle can be decelerated only by the regeneration operation at the timing at which the vehicle can be decelerated to the target speed only by the regeneration operation in the recognizable manner to the driver of the vehicle. Thus, according to a driving operation in accordance with this indication, it is possible to increase the amount of regenerated electric power and the time of the regeneration operation. Further, in contrast, by reducing the use of the mechanical brake, the energy consumed by the mechanical brake is suppressed, so that an increased amount of electric power to be regenerated can be expected.

In the above aspects, the calculation unit is configured to calculate the timing as a timing at which a distance or time that is obtained by adding the distance or time required until the speed of the vehicle becomes the target speed to the distance or time required until the driver starts the deceleration operation is a distance or time to the predicted target position.

According to the above aspect, it is possible to calculate the displayed timing as a more suitable timing. Thus, the indication that the vehicle can be decelerated only by the regeneration operation of the electric motor may be displayed at a more suitable timing.

In the above aspects, the prediction unit is configured to predict an intersection, a traffic signal area, or a temporary stop place as the target position. According to the above aspect, the target position can be easily determined, therefore it is possible to improve accuracy of the calculated timing. Note that, for a traffic light, in response to a signal cycle, it can be set as the target position when the vehicle is stopped, and not be set as the target position when the vehicle can pass through.

In the above aspects, the target speed is “0”. According to the above aspect, with respect to stop of the vehicle, the driving assist by which the deceleration is performed only by the regeneration operation can be performed optimally. Note that a stop position can be determined by a well known technique such as using map information, infrastructure information, and learning information.

In the above aspects, the index calculation unit is configured to calculate the index as a deceleration of the vehicle when the electric power regenerated by the electric motor is maximum. According to the above aspect, by setting the index as the deceleration when the electric power regenerated by the electric motor is maximum, that is, a so-called maximum regenerative deceleration, it is possible to utilize the maximum regenerative deceleration of the electric motor while performing a deceleration operation by which a large amount of electric power is regenerated.

In the above aspects, the index calculation unit is further configured to calculate a deceleration with which the vehicle is decelerated when the driver does not perform an acceleration or deceleration operation. According to the above aspect, by calculating the deceleration when the driver does not perform the acceleration or deceleration operation, it is possible to assist a stepwise deceleration operation based on two decelerations, the deceleration when the electric power regenerated by the electric motor is maximum and the deceleration when the driver does not perform the acceleration or deceleration operation. Note that a deceleration generated by drive mechanisms such as wheels and gears may be cited as an example of the deceleration when the driver does not perform the acceleration or deceleration operation.

In the above aspects, the calculation unit is configured to estimate a timing of switching to a state where the driver performs the acceleration or deceleration operation from a state where the driver does not perform the acceleration or deceleration operation, and calculate the timing based on the estimated timing, the deceleration with which the vehicle is decelerated when the driver does not perform the acceleration or deceleration operation, and the deceleration of the vehicle when the electric power regenerated by the electric motor is maximum.

According to the above aspect, it is possible to assist a stepwise deceleration operation at a suitable timing based on two decelerations, the deceleration when the electric power regenerated by the electric motor is maximum and the deceleration with which the vehicle is decelerated when the driver does not perform the acceleration or deceleration operation.

In the above aspects, the display unit is configured to display the indication that the vehicle can be decelerated only by the regeneration operation as an indication recommending the regeneration operation of the electric motor.

According to the above aspect, the driver may recognize that the regeneration of the electric motor is preferred, therefore it is possible to prompt the deceleration operation that is achieved by the regeneration operation (the regenerative braking). Thus, the possibility of actuating the mechanical brake is low, and the regeneration operation (the regenerative braking) may be performed at an earlier timing, so that more electric energy can be recovered and a suitable deceleration can be performed.

In the above aspects, the display unit is configured to display an indication that a current operating state of the electric motor is a state of being electrically driven, and an indication that a current operating state of the electric motor is a state of being regenerating electric power, and enable the indication that the vehicle can be decelerated only by the regeneration operation to be displayed in a position corresponding to the indication that the current operating state of the electric motor is a state of being regenerating electric power.

According to the above aspect, by using the indication of performing the deceleration only by the regeneration operation as the assist information and displaying the assist information in correspondence with the indication of the state of being regenerating electric power, the driver may recognize that performing the driving operation by the regeneration of the electric motor 24 is preferred, that is, only using the regenerative braking of the electric motor 24 is preferred. In other words, driving assist performed only by the regeneration operation of the electric motor is provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing a schematic structure of a first embodiment embodying a driving assist apparatus according to the present invention;

FIG. 2 is an explanatory diagram showing a relationship between a position of a vehicle when the vehicle is stopped at a target position and a display mode of a display unit in the first embodiment;

FIG. 3 is a graph illustrating calculation of a timing of changing the display mode of the display unit in the first embodiment:

FIG. 4 is a schematic diagram schematically showing the display unit of the first embodiment;

FIG. 5 is a schematic diagram schematically showing an indication related to driving assist displayed on the display unit of the first embodiment;

FIG. 6 is a schematic diagram schematically showing an example of an eco-driving indication displayed on the display unit of the first embodiment;

FIG. 7 is a graph illustrating calculation of a timing of changing a display mode of a display unit of a second embodiment embodying the driving assist apparatus according to the present invention;

FIG. 8 is a schematic diagram schematically illustrating a display mode of a display unit of another embodiment embodying the driving assist apparatus according to the present invention;

FIG. 9 is a schematic diagram schematically illustrating a display mode of yet another embodiment embodying the driving assist apparatus according to the present invention; and

FIG. 10 is a schematic diagram schematically showing an indication related to driving assist displayed on the display unit of the embodiment.

### DETAILED DESCRIPTION OF EMBODIMENTS

### First Embodiment

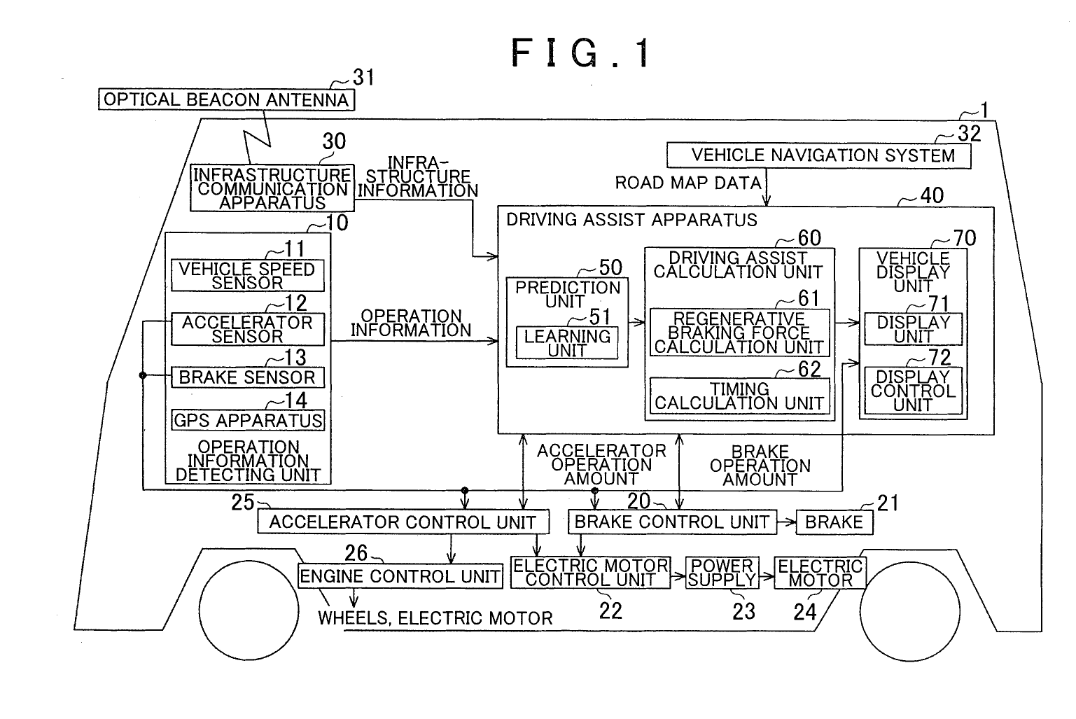

A first embodiment embodying a driving assist apparatus and a driving assist method will be described with reference to FIGS. 1 to 6. Note that a driving assist apparatus 40 of the present embodiment is mounted on a hybrid vehicle, for example, and a display unit 71 of the driving assist apparatus 40 is incorporated into an instrument panel that is provided in the vehicle such that various indications are displayed by the display unit 71 in a recognizable manner to a driver. In other words, the driving assist apparatus 40 can provide information related to a driving operation of high energy efficiency to the driver, such as during a deceleration.

As shown in FIG. 1, in a vehicle 1 to which the driving assist apparatus and the driving assist method is applied, there is provided an engine (not shown) and an electric motor 24 for driving wheels of the vehicle 1, and a power supply 23 as a power storage unit including a storage battery capable of exchanging electric energy with the electric motor 24. The electric motor 24 is electrically driven by electric power supplied from the power supply 23 to rotate the wheels, or can charge electric power regenerated by being mechanically driven by the wheels to the power supply 23. Further, in the vehicle 1, a mechanical brake 21 for providing a braking force to the vehicle 1 is provided.

Further, the vehicle 1 includes an engine control unit 26 for controlling a driving state of the engine, and an electric motor control unit 22 for controlling a driving state and a regeneration state of the electric motor 24. The engine control unit 26 is connected to the engine, and controls the driving state of the engine. Note that the engine control unit 26, except for causing the engine to drive the wheels, can also cause the electric motor 24 to be driven in order to regenerate electric power. The electric motor control unit 22 is connected to the power supply 23, and controls the driving state and the regeneration state of the electric motor 24 through an input and output control of electric power to the power supply 23.

The vehicle 1 is provided with an operation information detecting unit 10 for detecting a vehicle operation performed by the driver of the vehicle 1. The operation information detecting unit 10 includes a vehicle speed sensor 11 for detecting a speed of the vehicle 1, an accelerator sensor 12 for detecting an amount of depression by the driver of the vehicle 1 to an accelerator pedal, a brake sensor 13 for detecting an amount of depression by the driver of the vehicle 1 to a brake pedal, and a GPS apparatus 14 for detecting a current position of the vehicle 1.

Among these, the vehicle speed sensor 11 detects a rotation speed of the wheels of the vehicle 1, and outputs a signal corresponding to the detected rotation speed to the driving assist apparatus 40 and so on. The accelerator sensor 12 detects the operation amount by the driver of the vehicle 1 to the accelerator pedal, and outputs a signal corresponding to the detected operation amount to the accelerator pedal to the driving assist apparatus 40.

The brake sensor 13 detects the operation amount by the driver of the vehicle 1 to the brake pedal, and outputs a signal corresponding to the detected operation amount to the brake pedal to the driving assist apparatus 40.

The GPS apparatus 14 receives a GPS satellite signal, and detects the current position of the vehicle based on the received GPS satellite signal. Then, the GPS apparatus 14 outputs position information such as latitude and longitude indicating the detected current position of the vehicle to the driving assist apparatus 40.

The vehicle 1 includes an accelerator control unit 25 for controlling the driving states of the engine and the electric motor 24, and a brake control unit 20 for controlling the braking state of the brake 21 and the regeneration state of the electric motor 24. The accelerator control unit 25 and the brake control unit 20 are electrically connected to the operation information detecting unit 10 and the driving assist apparatus 40.

The accelerator control unit 25 controls a driving force applied to the vehicle 1, and calculates the driving force required for the vehicle 1 in accordance with the operation amount of the accelerator pedal that is input from the accelerator sensor 12.

Further, the accelerator control unit 25 suitably selects from a mode of consuming a charge storage amount of the storage battery, that is, a CD (Charge Depleting) mode, and a mode of maintaining the charge storage amount of the storage battery, that is, a CS (Charge Sustaining) mode.

The CD mode is a mode of actively consuming electric power charged in the storage battery instead of maintaining the charge storage amount of the storage battery, and is a mode of giving priority to travel that is achieved by the electric motor 24. Note that, even in the CD mode, if the accelerator pedal is largely depressed for a large vehicle power, the engine is driven.

The CS mode is a mode of maintaining the charge storage amount of the storage battery in a predetermined range with respect to a reference value, and is a mode of causing the engine to be driven and enabling the regeneration operation of the electric motor 24 as required in order to maintain the charge storage amount. Note that, even in the CS mode, if the charge storage amount of the storage battery is above the reference value, the engine is stopped. The reference value of the CS mode is suitably set as a value of the charge storage amount when it is changed from the CD mode to the CS mode, or a value of the charge storage amount required to maintain performance of the storage battery.

Then, the accelerator control unit 25 calculates distribution of the calculated driving force to the engine and the electric motor 24 in the selected CD mode or CS mode, and calculates a control amount of the engine and a control amount of the electric motor based on the calculated distribution of the driving force. Then, the driving state of the engine is controlled based on the calculated control amount of the engine, and the driving state of the electric motor is controlled based on the calculated control amount of the electric motor.

The brake control unit 20 is used for controlling the braking force to be applied to the vehicle 1, and calculating the braking force required for the vehicle 1 in accordance with the operation amount of the brake pedal input from the brake sensor 13. The brake control unit 20 calculates distribution of the calculated braking force to the brake 21 and the electric motor 24, and calculates the operation amount of the brake and a regeneration amount of the electric motor based on the calculated distribution. Then, the operating state of the brake 21 is controlled based on the calculated operation amount of the brake, and the state of the regeneration operation of the electric motor 24 is controlled based on the calculated regeneration amount of the electric motor, that is, a regenerative braking force is controlled based on the calculated regeneration amount of the electric motor.

Further, an infrastructure communication apparatus 30 for enabling road-vehicle communication is mounted on the vehicle 1. For example, the infrastructure communication apparatus 30 may be a communication apparatus for communicating with an optical beacon antenna 31 that is provided on the road via an optical signal such as infrared or wirelessly communicating with other vehicle with a wireless communication function. The optical beacon antenna 31 is disposed on the road at a position ahead of several hundred meters from an intersection at which a traffic light is provided. The optical beacon antenna 31 transmits information such as a distance to the intersection, a signal cycle of the traffic light that is provided at the intersection, a stop line position, and the road alignment as an infrastructure information signal. Moreover, for example, the infrastructure communication apparatus 30 receives the infrastructure information signal transmitted from the optical beacon antenna 31, and outputs the received infrastructure information signal to the driving assist apparatus 40.

Further, the infrastructure communication apparatus 30 receives road traffic information distributed from a VICS® center via the optical beacon antenna 31. The road traffic information may include, for example, traffic congestion information such as a traffic congestion section and a traffic congestion level, traffic regulation information such as road closure, and speed limit information.

Further, the vehicle 1 is provided with a vehicle navigation system 32. Road map data corresponding to a driving area of the vehicle 1 is registered in the vehicle navigation system 32, and is output to the driving assist apparatus 40. The road map data is information related to a map, and includes map display data, route search data, guidance data (such as intersection names, road names, district names, direction guidance facility information), and so on. The map display data is data for displaying a background of road map or road. The route search data is data consisting of branch information that is not directly related to a road shape and so on, and is mainly used when a recommended route is calculated (route search). The guidance data is data consisting of the intersections names and so on, and is used when the driver and so on is guided to the recommended route based on the calculated recommended route. Further, the road map data includes road attached information such as a road shape, an intersection of the road, and a crosswalk. Specifically, as the road attached information, it includes information such as a position at which a traffic light is provided, a position of an intersection at which a traffic light is provided, a position of an intersection at which no traffic light is provided, a temporary stop position, a railroad crossing, a road shape of the road, a tunnel, a crosswalk, an accident hotspot, and a road surface condition. The position at which the traffic light is provided and the position of the intersection at which the traffic light is provided may be cited as an example of the traffic signal area. The temporary stop position, the railroad crossing, the intersection at which no traffic light is provided and so on may be cited as an example of the temporary stop place. Note that, for the traffic light, in response to the signal cycle that is obtained from the infrastructure communication apparatus 30 and so on, it is possible to distinguish the case of stop from the case of passing through.

Then, information outputted from the operation information detecting unit 10, the infrastructure communication apparatus 30 and the vehicle navigation system 32 is suitably input to the driving assist apparatus 40 connected to these various apparatuses.

The driving assist apparatus 40 is electrically connected to the operation information detecting unit 10, the infrastructure communication apparatus 30, a vehicle navigation system 32, the accelerator control unit 25, and the brake control unit 20. Moreover, information required among the operation information of the operation information detecting unit 10, the infrastructure information of the infrastructure communication apparatus 30, the road map information of the vehicle navigation system 32 and so on is input to the driving assist apparatus 40. Further, information required among the information such as the driving state of the engine and the driving state of the electric motor of the accelerator control unit 25, the information such as the regeneration state of the electric motor and the operating state of the brake 21 of the brake control unit 20 and so on is input to the driving assist apparatus 40.

The driving assist apparatus 40 includes a prediction unit 50 for predicting that the vehicle 1 is decelerated to the target speed at a target position, a driving assist calculation unit 60 for determining a driving assist mode related to the deceleration operation performed by the driver of the vehicle 1, and a vehicle display unit 70.

For example, the prediction unit 50 predicts a position at which the vehicle 1 has the predetermined target speed including stop by deceleration, that is, the target position, based on the infrastructure information obtained by the infrastructure communication apparatus 30 and the road map data from the vehicle navigation system 32 (a prediction step). For example, the prediction unit 50 recognizes that the traveling speed of the vehicle 1 is “50 km/h” based on the operation information detected by the operation information detecting unit 10, and recognizes that a traffic light (the target position) is provided ahead in the traveling direction of the vehicle 1, a distance from the vehicle 1 to the traffic light, and a signal cycle of the traffic light, based on the infrastructure information obtained by the infrastructure communication apparatus 30. Then, the prediction unit 50 predicts whether the deceleration operation including stop operation performed by the driver of the vehicle 1 is required based on the traveling speed of the vehicle 1, the distance to the traffic light that is provided ahead in the traveling direction of the vehicle 1, and the signal, cycle of the traffic light. Note that, a temporary stop intersection, a signal light intersection, a railroad crossing, a curve of small radius of curvature at which a warning label such as “turn right” and “turn left” is provided and so on may be cited as an example of the target position at which the speed of the vehicle 1 reaches the target speed including stop by the deceleration operation or stop operation performed by the driver.

Further, for example, the prediction unit 50 recognizes the intersection, the traffic signal area, the temporary stop position, the curve, a traffic element that is a main cause of decelerating to the target speed by the deceleration operation such as speed limit and the stop operation, which are present in the route to a destination, based on the road map data inputted from the vehicle navigation system 32, and set them as the target position. Then, the prediction unit 50 recognizes whether the vehicle 1 is approaching the target position based on latitude and longitude information of the set target position and the current position information of vehicle 1 detected by the GPS apparatus 14, to predict that the vehicle 1 is decelerated to the target speed by the deceleration operation performed by the driver.

Further, the prediction unit 50 is provided with a learning unit 51 for learning the vehicle operation performed by the driver of the vehicle 1. The learning unit 51 determines the traffic element such as the intersection, the traffic light, and the curve, and the target position that is a main cause when the driver of the vehicle 1 performs the deceleration operation or the stop operation such as accelerator off and brake on/off. The learning unit 51 obtains the position information such as latitude and longitude of the vehicle 1 at which the deceleration operation or the stop operation performed by the driver of vehicle 1 is completed from the GPS apparatus 14, and learns a position indicated by the obtained position information as the target position of the deceleration operation or the stop operation performed by the driver of the vehicle 1. Further, the prediction unit 50 learns the speed of the vehicle at the leaned target position such as stop and a predetermined speed as the target speed in association with the corresponding target position. Then, the prediction unit 50 recognizes whether the vehicle 1 is approaching the traffic element that is the main cause of requiring the deceleration operation or the stop operation based on a learning result obtained by this learning unit 51 and so on, to predict that the vehicle 1 requires to be decelerated to the target speed by the deceleration operation performed by the driver.

In this way, the prediction unit 50 predicts the target position that is the main cause of decelerating the vehicle to the target speed by the deceleration operation performed by the driver, and outputs the prediction result to the driving assist calculation unit 60.

The driving assist calculation unit 60 calculates the driving assist mode to be performed for the driver of the vehicle 1 based on the prediction result input from the prediction unit 50. The driving assist calculation unit 60 includes a regenerative braking force calculation unit 61 that is an index calculation unit for calculating a braking force obtained by the regeneration operation of the electric motor 24, and a timing calculation unit 62 for calculating a timing of performing the driving assist in order to arrive at the target position with the target speed only by the regeneration operation of the electric motor 24 (the regenerative braking), for example, stop at the target position.

The regenerative braking force calculation unit 61 calculates a maximum braking force that can be generated by the regeneration of the electric motor 24 based on specifications of the electric motor 24 and the power supply 23, that is, calculates a maximum deceleration generated by the regeneration (the maximum regenerative deceleration) (an index calculation step). In other words, the calculation is performed by taking the deceleration of the vehicle when the electric power regenerated by the electric motor 24 is maximum as the maximum deceleration. The calculated maximum deceleration at this time constitutes an index indicating that the vehicle 1 can be decelerated only by the regeneration operation of the electric motor 24. With the maximum regenerative deceleration calculated in this way, it is possible to calculate time and a travel distance required until the vehicle 1 is decelerated to the target speed only by the regeneration operation of the electric motor 24 (the regenerative braking). The regenerative braking force calculation unit 61 may calculate the maximum regenerative deceleration based on the specifications of the electric motor 24 and the power supply 23 stored in the driving assist calculation unit 60, or obtain information required for calculating the maximum regenerative deceleration from the brake control unit 20 and the electric motor control unit 22.

Here, the relationship between the maximum regenerative deceleration and the time and the distance will be described. For example, when a deceleration required for decelerating the vehicle 1 such that the vehicle 1 arrives at the target position with the target speed is equal to or less than the maximum regenerative deceleration, the vehicle 1 can arrive at the target position with the target speed by the deceleration that is achieved only by the regeneration operation of the electric motor 24 (the regenerative braking). In contrast, for example, when the deceleration required for decelerating the vehicle 1 such that the vehicle 1 arrives at the target position with the target speed is larger than the maximum regenerative deceleration, the vehicle 1 can not arrive at the target position with the target speed by the deceleration that is achieved only by the regeneration operation of the electric motor 24 (the regenerative braking). That is, in order for the vehicle 1 to arrive at the target position with the target speed, the vehicle 1 is decelerated to the target speed by a combination of the regeneration operation of the electric motor 24 (the regenerative braking) and the brake 21. In this case, the kinetic energy reduced by the brake 21 can not be recovered, therefore the energy efficiency of the vehicle 1 is reduced by an amount corresponding to the kinetic energy reduced by using the brake 21. In other words, if the vehicle can be decelerated only by the regeneration operation of the electric motor 24 (the regenerative braking), it is possible to recover the kinetic energy of the vehicle as electric energy, and improve the energy efficiency of the vehicle 1. At this time, in the hybrid vehicle, fuel efficiency is improved, and electric power consumption is suppressed, that is, a so-called power cost is improved.

The current position of the vehicle 1 detected by the GPS apparatus 14, the target position that is the main cause of decelerating the vehicle 1 to the target speed that is predicted by the prediction unit 50, and the target speed at the target position are input to the timing calculation unit 62. If the timing calculation unit 62 determines that the vehicle 1 is approaching the target position based on the input current position of the vehicle 1 and the target position predicted by the prediction unit 50, the timing calculation unit 62 calculates the remaining distance and the remaining time from the current position of the vehicle 1 to the target position. Further, the timing calculation unit 62 calculates a deceleration distance and a deceleration time required for the vehicle 1 to have a target speed when it arrives at the target position based on the traveling speed of the vehicle 1 and the deceleration of the vehicle 1. In the present embodiment, by calculating the deceleration distance and the deceleration time such that the speed of the vehicle 1 becomes the target speed at the target position by the deceleration that is achieved only by the regeneration operation of the electric motor 24 (the regenerative braking), the deceleration of the vehicle 1 is caused to be the maximum regenerative deceleration. Thus it is possible to recover the kinetic energy reduced during deceleration as electric energy. Note that, the timing calculation unit 62 determines that the vehicle 1 is approaching the target position at a timing which can secure the deceleration distance and deceleration time, and calculates the remaining distance and the remaining time to the target position at this time. In this way even after determining that the vehicle 1 is approaching the target position, the deceleration distance and the deceleration time can be secured.

Then, the timing calculation unit 62 calculates the timing of providing driving assist to the driver of the vehicle 1 based on the calculated deceleration distance and the calculated deceleration time. In the above driving assist a deceleration such as accelerator off and brake depression (the regenerative braking) is recommended. In the present embodiment, the timing calculation unit 62 calculates the timing of recommending the deceleration as a timing at which the distance is before the deceleration distance and the time is earlier than the deceleration time. Typically, although an indication recommending the deceleration is often displayed when the traveling position of the vehicle 1 corresponds to the deceleration distance and the deceleration time with respect to the target position, a delay until the driver recognizes such an indication and performs the recommended operation, for example, a delay of reaction time of the driver, is generated. That is, even the indication recommending the deceleration is displayed on the display unit 71, the driving operation performed by the driver would not be switched immediately to the deceleration operation by which the vehicle 1 is decelerated with the maximum regenerative deceleration. Therefore, the timing calculation unit 62 considers the deceleration distance and the deceleration time together with the reaction distance and the reaction time required for the driver to switch the driving operation, and calculates the timing at which the vehicle 1 arrives at the target position with the target speed by the deceleration that is achieved only by the regeneration operation of the electric motor 24 (the regenerative braking) (a calculation step).

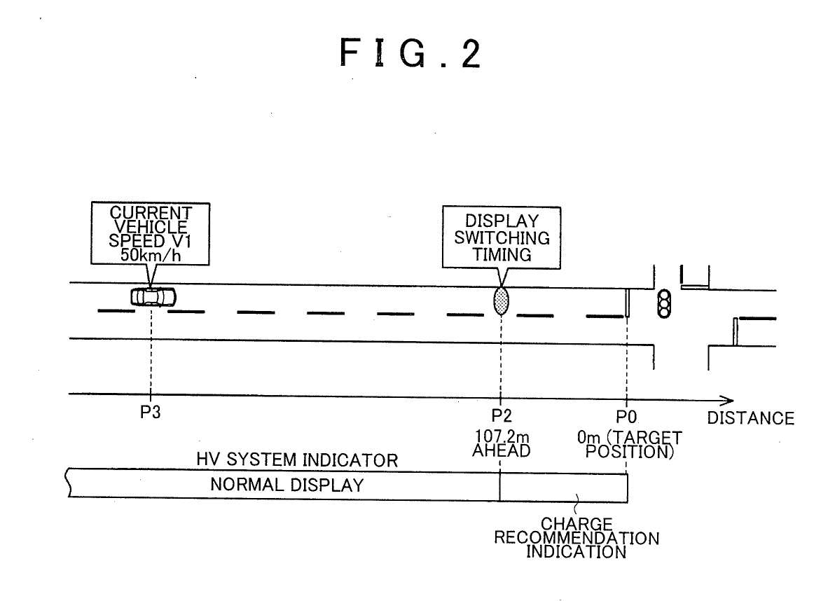

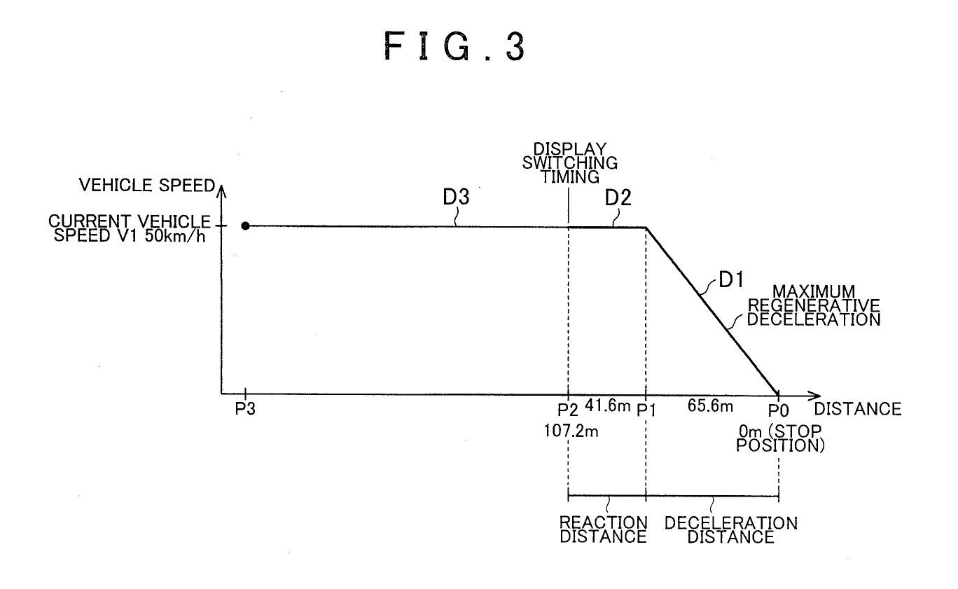

Therefore, an example of details of the timing calculated by the timing calculation unit 62 will be described with reference to FIGS. 2 and 3. Note that, in the following, the case of calculating the timing at which the deceleration can be performed only by the regeneration operation of the electric motor (the regenerative braking) is described, and the description of the case of calculating the timing based on time will be omitted.

As shown in FIG. 2, the vehicle 1 is on a road in which a traffic signal intersection is provided at a target position PO, and travels through a current position P3 from a position before the target position P0, that is, the current position P3, toward the target position P0 with a vehicle speed V1 (50 km/h). Further, it is assumed that the vehicle 1 must be stopped at the target position P0 in the traveling direction thereof. At this time, the driving assist apparatus of the present embodiment displays a driving assist indication that the vehicle 1 can be stopped at the target position P0 only by the regeneration operation of the electric motor 24 (the regenerative braking) from the vehicle 1 reaching the display switching timing P2, that is, an indication recommending a deceleration operation. Note that, in FIG. 2, the indication recommending the deceleration operation is displayed as “Recommended Charge Display”, and the others except for the indication are displayed as “Normal Display”. In other words, during a period of the traveling position of the vehicle 1 from the current position P3 to the display switching timing P2, “Normal Display” is displayed on the display unit 71, when reaching the display switching timing P2, the indication on the display unit 71 is switched from “Normal Display” to “Recommended Charge Display”, and during a period from the display switching timing P2 to the target position P0, “Recommended Charge Display” is displayed.

As shown in FIG. 3, the timing calculation unit 62 calculates the deceleration distance required for reducing the current vehicle speed V1 (50 km/h) to the target speed (0 km/h) when the vehicle 1 is decelerated with the maximum regenerative deceleration Da. First of all, generally, a relationship between acceleration or deceleration and distance is expressed as following Equation 1. Note that, V0 [m/s] is an initial speed (the current speed), Vc [m/s] is the target speed, a [m/ŝ2] is the acceleration or deceleration, s is the distance [m], and “̂2” is an operation of square.

(Vĉ2)−(V0̂2)=2as Equation 1

Thus, generally, the deceleration distance is calculated based on the following Equation 2 derived from the above Equation 1.

deceleration distance=((target speed̂2)−(current speed̂2))/(2×acceleration or deceleration) Equation 2

For example, the deceleration distance when the target speed is 0 [km/h], the current speed is 50 [km/h], and the acceleration or deceleration (the maximum regenerative deceleration Da) is −0.15 [G] is calculated based on the above Equation 2 as shown in the following Equation 3. Noted that “G” is 9.8 [m/(ŝ2)],

deceleration distance=((0̂2)−((50/3.6)̂2))/(2×(−0.15×9.8))=65.6 [m] Equation 3

Thus, the timing calculation unit 62 calculates a position ahead in a distance of 65.6 [m] from the target position P0 (a position closer to the current position of the vehicle 1) as a brake start point P1.

Next, the timing calculation unit 62 calculates the reaction distance of the driver. The driving reaction distance is calculated based on the following Equation 4. The reaction distance is calculated as a distance that the vehicle 1 travels until the driver recognizes the indication recommending the deceleration that is displayed on the display unit 71 and performs the recommended deceleration operation.

reaction distance=reaction time×current vehicle speed Equation 4

Therefore, when the reaction time from the driver recognizes the indication recommending the deceleration until the driver performs the deceleration operation is 3 seconds, the reaction distance is calculated as the following Equation 5.

reaction distance=3×(50/3.6)=41.6 [m] Equation 5

Therefore, the timing calculation unit 62 calculates the reaction distance as a distance from the brake start point P1 until a position ahead of 41.6 [m], that is, the display switching timing P2.

Therefore, the timing calculation unit 62 determines the brake start point P1 at the position ahead in the distance of 65.6 [m] from the target position P0, and determines the display switching timing P2 at the position ahead in the reaction distance of 41.6 [m] from the brake start point P1. In other words, the display switching timing P2 is positioned between the current position P3 of the vehicle 1 and the target position P0, and determined at a position ahead of 107.2 [m] from the target position P0.

Then, the driving assist calculation unit 60 outputs a signal for displaying the indication recommending the deceleration on the display unit 71 to the vehicle display unit 70, when the current position P3 of the vehicle 1 reaches the display switching timing P2 that is calculated in this way by the timing calculation unit 62.

For example, if a driving operation is performed at this display switching timing P2 calculated by the timing calculation unit 62, the speed of the vehicle 1 that is the vehicle speed V1 is maintained to the vehicle speed V1 in a section D3 from the current position P3 to the display switching timing P2 and a section D2 from the display switching timing P2 to the brake start point P1. Meanwhile, the indication recommending the deceleration is displayed from the display switching timing P2. Therefore, once the vehicle 1 travels through the reaction distance with the vehicle speed V1, the deceleration operation is started. The vehicle 1 is decelerated in the section D1 from the brake start point P1 to the target position P0 with the maximum regenerative deceleration Da, and is stopped at the target position P0.

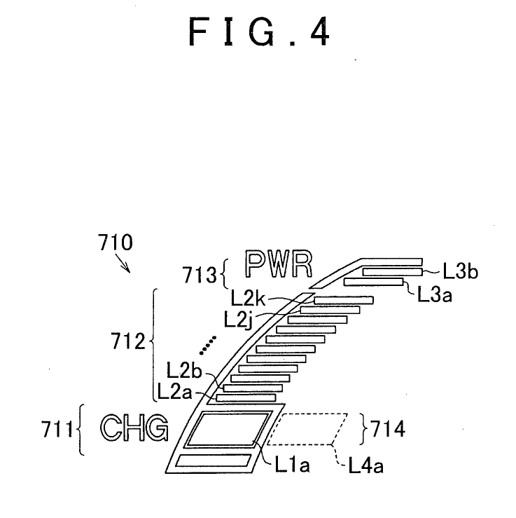

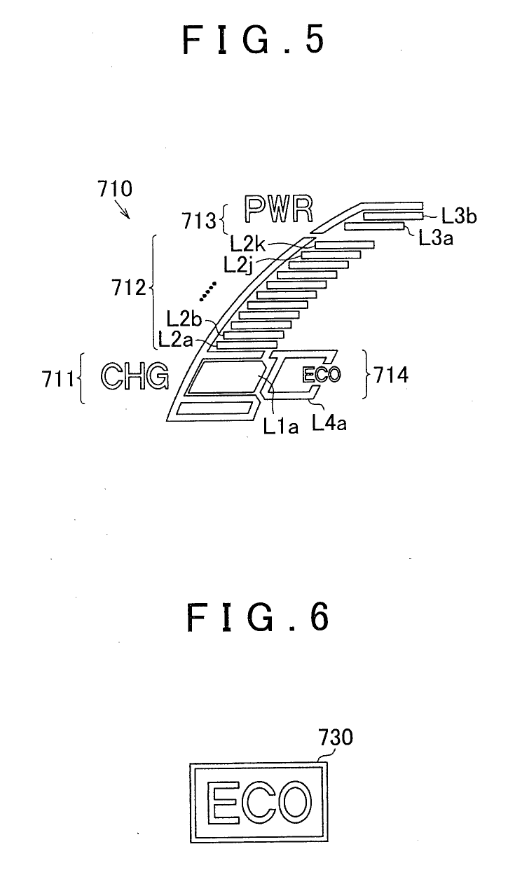

Next, the indication recommending the deceleration to enable such driving operation will be described with reference to FIGS. 4 and 5. The vehicle display unit 70 is a display apparatus for displaying the driving state of the engine, the driving state and the regeneration state of the electric motor 24, the operating state of the brake 21 and so on to the driver, and is a so-called hybrid system indicator. In the present embodiment, the vehicle display unit 70 displays the indication that the vehicle 1 can arrive at the target position with the target speed by the deceleration that is achieved only by the regeneration operation of the electric motor 24 (the regenerative braking) as the indication recommending the deceleration. Various information of the engine, the electric motor 24, the brake 21 and so on is input to the vehicle display unit 70.

The vehicle display unit 70 includes the display unit 71 for visually displaying information about the vehicle operation, and a display control unit 72 for controlling a display mode of the display unit 71. In order to make the display unit 71 to perform a predetermined display, the display control unit 72 provides an instruction regarding display to the display unit 71. The display control unit 72 controls display contents of the display unit 71 based on the various information of the engine, the electric motor 24, the brake 21 and so on, such that the display unit 71 displays an indication corresponding to the various information.

For example, the display unit 71 is disposed in the instrument panel, and disposed at a position that is visible to the driver of the vehicle 1. Further, the display unit 71 is a so-called hybrid system indicator, which displays fuel efficiency and remaining storage amount of the storage battery, and displays an operating condition of a hybrid system. The operating condition of the hybrid system includes an indication such as information indicating the operating state of the engine, information indicating the operating state of the electric motor 24, and information indicating the regeneration state of the electric motor 24. In the present embodiment, information for recommending the deceleration of the vehicle 1 to the driver can be visually displayed together with the operating condition of the hybrid system.

First of all, the information displayed on the display unit 71 will be described with reference to FIG. 4. A level meter 710 indicating the operating state of the engine, the operating state and the regeneration state of the electric motor 24 is displayed on the display unit 71.

The level meter 710 includes a CHG (charge) area 711 indicating that the electric motor 24 is operating for regeneration, an electric motor driving area 712 indicating that the vehicle is driven by the electric motor 24 to travel, and a PWR (power) area 713 indicating that the engine is operating for traveling. Note that the PWR area 713 may be a state where the engine is operating alone, or a state where the engine and the electric motor 24 cooperate with each other.

The CHG area 711 is an indication that the electric motor 24 is operating for regeneration, and has a lighting area L1a. The lighting area L1a is lighted in accordance with a lighting signal output from the display control unit 72 and doused when there is no lighting signal, in which information indicating that the electric motor 24 is in the regeneration state is input to the display control unit 72 from the brake control unit 20.

The electric motor drive area 712 is an indication that the electric motor 24 is being driven by electric power. The output of the electric motor 24 is indicated by the number of gauges which are arranged vertically and lighted, therefore a plurality of lighting gauges L2a to L2k are provided. The lighting gauges L2a to L2k are lighted in accordance with the lighting signal output from the display control unit 72, in which the number of the lighted gauges corresponds to input power information. The power information regarding that the electric motor 24 is driven by electric power to output is input to the display control unit 72 from the accelerator control unit 25. In this case, when the output power is minimum, the display control unit 72 lights the lighting gauge L2a and douses the lighting gauges L2b to L2k. Further, when the output power is maximum, the display control unit 72 lights all the lighting gauges L2a to L2k. In other words, the display control unit 72 is configured to divide between the minimum value and the maximum value of the input power according to the number of the lighting gauges, and corresponds to the number of the lighting gauges in a manner that the larger the power range is the more the number of lighted gauges is. For example, when the number of lighted gauges is “1”, the gauge L2a is lighted correspondingly, when the number of lighted gauges is “2”, the gauges L2a, L2b are lighted correspondingly, and when the number of lighted gauge is “3”, the gauges L2a, L2b, L2c are lighted correspondingly. In a similar way thereafter, when the number of lighted gauges is “9”, the gauges L2a to L2i are lighted correspondingly, when the number of lighted gauges is “10”, the gauges L2a to L2j are lighted correspondingly, and when the number of lighted gauges is “11”, the gauges L2a to L2k are lighted correspondingly.

The PWR area 713 is an indication that the engine is being driven. Two lighting gauges L3a, L3b corresponding to the magnitude of the output of the engine are arranged vertically in the PWR area 713. The PWR area 713 is lighted according to the lighting signal output from the display control unit 72 and doused when there is no lighting signal. Information regarding that the engine is driven is input to the display control unit 72 from the accelerator control unit 25.

In this way, the level meter 710 notifies the driver that the electric motor 24 is operating for regeneration through the display control of the display control unit 72 based on various information of the electric motor 24 and so on and by means of the display of the CHG area 711. Further, the level meter 710 notifies the driver that the electric motor 24 is operating for regeneration and the output at this time through the display control of the display control unit 72 based on various information of the electric motor 24 and so on and by means of the number of lighting gauges L2a to L2k which are lighted in the electric motor drive area 712. Further, the level meter 710 notifies the driver that the engine is operating through the display control of the display control unit 72 based on various information of the engine and so on and by means of the display of the PWR area 713.

Further, as shown in FIG. 5, the level meter 710 includes a recommendation display area 714 for displaying the indication recommending the deceleration, and the recommendation display area 714 includes a recommendation indication L4a that is lighted by the control of the display control unit 72. The recommendation indication L4a of the recommendation display area 714 displays an ECO (Economic Cooperation Organization) indication, so that the display control unit 72 controls the recommendation indication L4a of the recommendation display area 714 to be lighted according to a signal indicating the display switching timing P2 that is input from the driving assist calculation unit 60. Thus, the indication that the vehicle 1 can be decelerated only by the regeneration operation of the electric motor 24 can be displayed in a recognizable manner to the driver of the vehicle 1 (a display step).

In detail, the recommendation display area 714 indicates that the deceleration is recommended, and is used for promoting the driver to perform the deceleration operation. The recommendation display area 714 is disposed at a position arranged laterally in the CHG area 711. In this way, by disposing the recommendation display area 714 at the position arranged laterally in the normally displayed CHG area 711, it is possible to display the recommendation display area 714 as additional assist information on the display of the CHG area 711, and therefore it is possible to reduce the inconvenience of the driver to the display of such assist information.

Further, by disposing the recommendation display area 714 at the position arranged laterally in the CHG area 711, the case where the display corresponds to the CHG area 711 becomes clear. Thus, when the recommendation indication L4a of the recommendation display area 714 is lighted, the driver can recognize that a state where the CHG area 711 is lighted, that is, the electric motor 24 is in the regeneration state, is preferred as a driving state of the vehicle 1. Thus, the driver performs the regeneration operation of the electric motor 24 (the regenerative braking) with a deceleration close to the maximum regenerative deceleration through the deceleration operation of depressing the brake pedal performed by recognizing that the recommendation display area 714 is lighted. Note that, although the depression amount of the brake pedal, that is, the deceleration, is not notified to the driver, if the target position at which the vehicle 1 is stopped or the like is clear, the deceleration of the vehicle generated by the driver is determined naturally toward the target position. In other words, if the deceleration operation performed by the driver is started from the brake start point P1, the deceleration of the vehicle 1 at this time naturally becomes the deceleration close to the maximum regenerative deceleration Da.

On the other hand, if the deceleration operation performed by the driver is started at an early stage to the target position, an excess deceleration occurs and there is a possibility that a re-acceleration is required in order to arrive at the target position. Therefore, as in the present embodiment, with the indication recommending the deceleration by lighting the recommendation display area 714, the driver can recognize a suitable deceleration timing, and it is possible to suppress the early deceleration operation. In this way, with the indication recommending the deceleration, it is possible to avoid the early deceleration, therefore the possibility that the re-acceleration occurs can be reduced, to assist the driving operation of high energy efficiency by which the vehicle 1 can be decelerated only by the regeneration operation of the electric motor 24 (the regenerative braking).

Further, as shown in FIG. 6, it is conventionally known that an ECO indication 730 is displayed in order to indicate that a driving of high energy efficiency is being performed when traveling only with the electric motor 24 without performing a sudden acceleration or deceleration. Moreover, it is widely known that it is sufficient for the driver to perform a suitable acceleration operation in order to display the ECO indication 730. However, although this ECO indication 730 notifies the driver that the energy efficiency is improved as a result of the driving operation, it can not indicate what driving operation can improve the energy efficiency to display the ECO indication 730.

According to the operation of the present embodiment, it is possible to calculate the display switching timing P2 at which the vehicle 1 can be decelerated to the target speed only by the regeneration operation based on a distance obtained by adding the deceleration distance to the reaction distance, when the vehicle 1 is stopped toward the target position P0. Then, when the current position of the vehicle 1 reaches the display switching timing P2, the charge recommendation indication L4a that the vehicle 1 can be decelerated to the target speed only by the regeneration operation is displayed on the display unit 71 in a recognizable manner to the driver. Thus, according to the driving operation in accordance with this indication, it is possible to increase the amount of regenerated electric power and the time of the regeneration operation.

According to the present embodiment, there is provided a driving assist apparatus which can provide assist information by which more electric energy can be regenerated when a vehicle is decelerated, in particular, there is provided assist information which can indicate when to perform the regeneration operation of the electric motor 24 (regenerative braking) by using the brake operation.

As described above, according to the driving assist apparatus and the driving assist method according to the present embodiment, it is possible to obtain effects as listed below. (1) At the display switching timing P2 at which the vehicle 1 can be decelerated to the target speed only by the regeneration operation, the recommendation indication L4a that the vehicle 1 can be decelerated only by the regeneration operation is displayed on the display unit 71 in a recognizable manner to the driver. Thus, according to the driving operation in accordance with this indication, it is possible to increase the amount of regenerated electric power and the time of the regeneration operation. Further, in contrast, by reducing the use of the mechanical brake 21, the energy consumed by the mechanical brake 21 is suppressed, so that an increased amount of electric power to be regenerated can be expected.

Further, with the recommendation indication L4a that the vehicle 1 can be decelerated only by the regeneration operation, it is possible to guide explicitly the brake operation that is achieved only by the regeneration operation, so that more energy can be recovered by the regeneration.

Further, using the target position P0 to calculate the time and distance required until the speed of the vehicle 1 becomes the target speed, for the target position P0, it is possible to calculate the display switching timing P2 at which the vehicle 1 can be decelerated only by the regeneration operation. Note that, the target position P0 can be determined by using a well known technique such as such as using map information, infrastructure information, and learning information such as driving history.

(2) By calculating the display switching timing P2 based on the distance obtained by adding the distance required until the speed of the vehicle 1 becomes the target speed to the distance required until the driver starts the deceleration operation, it is possible to calculate the display switching timing P2 as a more suitable timing. Thus, the indication that the vehicle 1 can be decelerated only by the regeneration operation of the electric motor 24 may be displayed at a more suitable timing.

(3) By predicting the target position as a intersection, a traffic signal area, or a temporary stop place, the target position P0 can be easily determined. Therefore, it is possible to improve accuracy of the calculated display switching timing P2. Note that, for a traffic light, in response to a signal cycle, it is possible to be set as the target position when the vehicle is stopped, and not to be set as the target position when the vehicle can pass through.

(4) By setting the target speed as “0 (km/h)”, as for stop of the vehicle, the driving assist by which the deceleration is performed only by the regeneration operation can be performed optimally. Note that a stop position can be determined by a well known technique such as using map information, infrastructure information, and learning information.

(5) By setting the index as the deceleration when the electric power regenerated by the electric motor 24 is maximum, that is, a so-called maximum regenerative deceleration, it is possible to utilize the maximum regenerative deceleration of the electric motor 24 while performing a deceleration operation by which a large amount of electric power is regenerated.

(6) By displaying the recommendation indication L4a, the driver may recognize that the regeneration of the electric motor 24 is preferred, therefore it is possible to prompt the deceleration operation that is achieved by the regeneration operation (the regenerative braking). Thus, the possibility of actuating the mechanical brake 21 is low, and the regeneration operation may be performed at an earlier timing, so that more electric energy can be recovered and a suitable deceleration can be performed.

(7) Further, by using the indication (the recommendation display L4a) of performing deceleration only by the regeneration operation as assist information and displaying the assist information in correspondence with the indication (the CHG area 711) of the state of being regenerating electric power, the driver may recognize that performing the driving operation by the regeneration of the electric motor 24 is preferred, that is, only using the regenerative braking of the electric motor 24 is preferred. In other words, driving assist performed only by the regeneration operation of the electric motor 24 is provided. Further, the driving state of the electric motor 24 is displayed, therefore by displaying the additional recommendation indication L4a to this display, it is possible to reduce the inconvenience of the driver to the display of such recommendation indication L4a.

### Second Embodiment

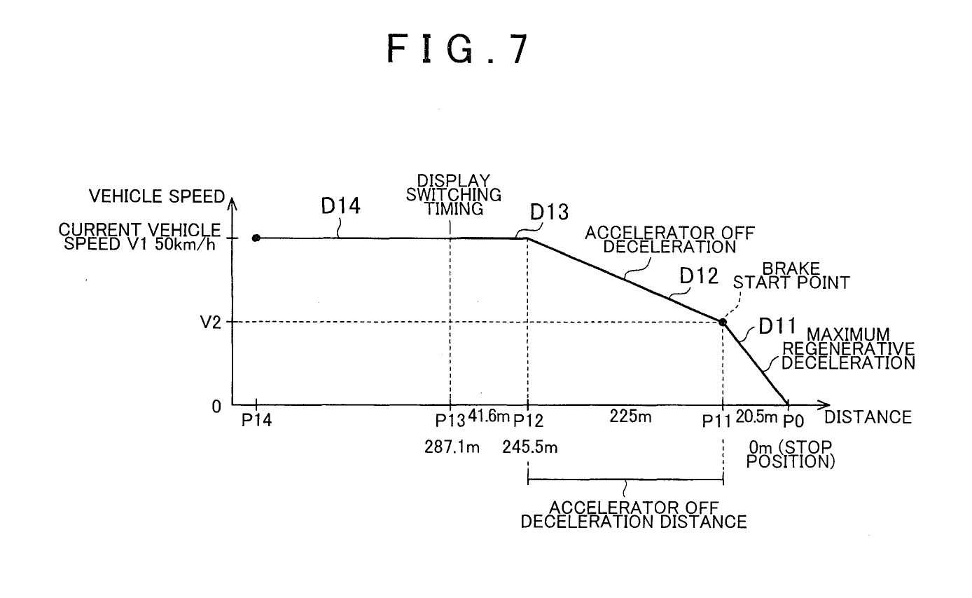

A second embodiment embodying the driving assist apparatus and the driving assist method will be described with reference to FIG. 7.

In the present embodiment, the method of calculating the display switching timing is different from the method of calculating the display switching timing of the first embodiment, but the other configuration is similar. Therefore, in the following, the configuration different from the first embodiment is described. For convenience of explanation, the same reference numbers are given for the same structure, and the detailed description thereof will be omitted.

Note that, in the present embodiment, the deceleration operation of the driver to the target position P0 is configured of the reaction distance, an accelerator off deceleration distance and a brake deceleration distance. The configuration of such a deceleration operation may be preset as a general trend, or may be included in the infrastructure information and the road map information, or may be determined as a result of learning the driving operation of the driver to the target position.

As shown in FIG. 7, the timing calculation unit 62 calculates the deceleration distance by the maximum regenerative deceleration sequentially from the target position P0 toward a current position P14 of the vehicle 1, and set it as a section D11 from the target position P0 to a brake start point P11. Further, the timing calculation unit 62 calculates the accelerator off deceleration distance by the deceleration when the accelerator is off, as a section D12 from the brake start point P11 to an accelerator off timing P12. Further, the timing calculation unit 62 calculates the reaction distance, as a section D13 from the accelerator off timing P12 to a display switching timing P13. In other words, the timing calculation unit 62 set the display switching timing P13 at a position adding the deceleration distance, the accelerator off deceleration distance and the reaction distance from the target position P0.

The following will describe an example that the timing calculation unit 62 calculates the display switching timing P13. The timing calculation unit 62 calculates a vehicle speed V2 at the brake start point P11 at which the driver starts a brake operation. In the present embodiment, it is assumed that the vehicle speed V2 is 28 km/h. Then, the timing calculation unit 62 calculates the deceleration distance required for the vehicle speed V2 (28 km/h) to reduce to a target speed (0 km/h) when the vehicle 1 is decelerated with the maximum regenerative deceleration Da. In other words, the deceleration distance when the target speed is 0 [km/h], the current speed is 28 [km/h], and the acceleration or deceleration (the maximum regenerative deceleration Da) is −0.15 [G] is calculated as the following Equation 6 based on Equation 2 described in the first embodiment.

deceleration distance=((0̂2)−((28/3.6)̂2))/(2×(−0.15×9.8))=20.5 [m] Equation 6

Thus, the timing calculation unit 62 calculates the brake start point P11 as a position ahead of 20.5 [m] from the target position P0.

Next, the timing calculation unit 62 calculates the accelerator off deceleration distance required for a vehicle speed V1 (50 km/h) to be reduced to the vehicle speed V2 (28 km/h) when the vehicle 1 is decelerated with an accelerator off deceleration Db. In other words, the accelerator off deceleration distance when the target speed is 28 [km/h], the current speed is 50 [km/h], and the acceleration or deceleration (the accelerator off deceleration Db) is −0.03 [G] is calculated as the following Equation 7 based on Equation 2 described in the first embodiment. Note that, the accelerator off deceleration Db is a deceleration generated by the engine brake, or is an obtained value that is predetermined by the regenerative braking force calculation unit 61, or is calculated from the specification of the vehicle 1.

accelerator off deceleration distance=((28/3.6)̂2−(50/3.6)̂2)/(2×(−0.03×9.8))=225 [m] Equation 7

Thus, the timing calculation unit 62 calculates the accelerator off timing P12 as a position ahead of 225 [m] from the brake start point P11.

Next, the timing calculation unit 62 calculates the reaction time of the driver. The driver reaction distance is calculated as the reaction distance=3×(50/3.6)=41.6 [m] by Equation 5 described the first embodiment based on Equation 4 described in this embodiment.

In other words, the timing calculation unit 62 calculates the display switching timing P13 as a position ahead of the vehicle 1 of 41.6 [m] from the accelerator off timing P12. Therefore, the timing calculation unit 62 determines the brake start point P11 at a position ahead of 20.5 [m] from the target position P0, and determines the accelerator off timing P12 at a position ahead of 225 [m] that is the accelerator off deceleration distance from the brake start point P11. Further, the timing calculation unit 62 determines the display switching timing P13 at a position ahead of 41.6 [m] that is the reaction distance from the accelerator off timing P12. In other words, the display switching timing P13 is positioned between the current position P14 of the vehicle 1 and the target position P0, and is determined at a position ahead of 287.1 [m] from the target position P0.

Then, the driving assist calculation unit 60 outputs a signal for displaying an indication recommending a deceleration on the display unit 71 to the vehicle display unit 70 when the current position P14 of the vehicle 1 reaches the display switching timing P13 that is calculated in this way by the timing calculation unit 62.

For example, when the driving operation is performed by the display switching timing P13 that is calculated by the timing calculation unit 62, the speed of the vehicle 1 of the vehicle speed V1 is maintained to the vehicle speed V1 in the section D14 from the current position P14 to the display switching timing P13 and the section D13 from the display switching timing P13 to the accelerator off timing P12. Meanwhile, the indication recommending the deceleration is displayed from the display switching timing P13. Therefore, the vehicle 1 traveling with the vehicle speed V1 firstly starts an accelerator off operation, and is decelerated with the accelerator off deceleration Db in the section D12 from the accelerator off timing P12 to the brake start point P11, the speed when it reaches the brake start point P11 is the vehicle speed V2 (28 km/h). Then, the vehicle 1 that has a speed of the vehicle speed V2 when it reaches the brake start point P11 starts to be decelerated by depression of the brake pedal, is decelerated with the maximum regenerative deceleration Da in the section D11 from the brake start point P11 to the target position P0, and is stopped at the target position P0.

As described above, according to the driving assist apparatus and the driving assist method according to the present embodiment, in addition to the effects (1) to (7) described in the previous first embodiment, it is possible to obtain effects as listed below.

(8) The regenerative braking force calculation unit can assist a stepwise deceleration operation based on two decelerations, the deceleration when the electric power regenerated by the electric motor 24 is maximum and the deceleration when the driver does not perform the acceleration or deceleration operation by calculating the deceleration when the driver does not perform the acceleration or deceleration operation in combination. Note that a deceleration generated by drive mechanisms such as wheels and gears may be cited as an example of the deceleration when the driver does not perform the acceleration or deceleration operation.

(9) It is possible to assist a stepwise deceleration operation at a suitable timing, that is, at the accelerator off timing P12 and the brake start point P11, based on two decelerations, the deceleration when the electric power regenerated by the electric motor 24 is maximum and the deceleration with which the vehicle is decelerated when the driver does not perform the acceleration or deceleration operation.

### Other Embodiments

Note that the above embodiments may also be embodied in the following manner. In the above embodiments, the case where the recommendation indication L4a for recommending the brake operation is displayed in the recommendation display area 714 of the level meter 710 is illustrated. However, the invention is not limited to this, and except for the recommendation indication L4a (ECO indication) for recommending the brake operation, the level meter may display the ECO indication in a range in which an acceleration operation is suitable.

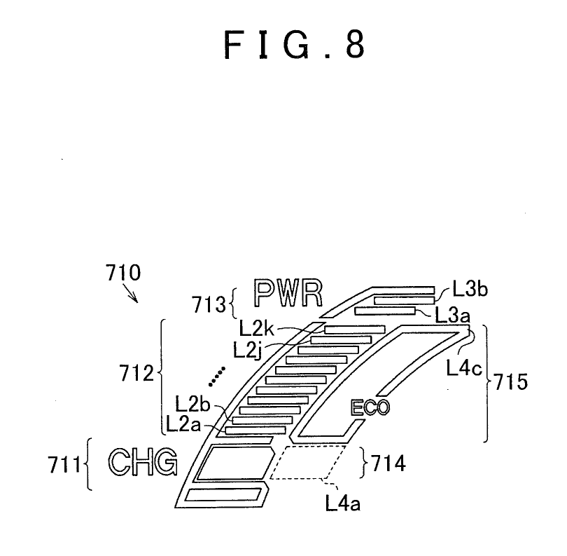

For example, as shown in FIG. 8, a recommendation display area 715 indicating the range in which the acceleration operation is suitable is disposed at a position corresponding to the electric motor drive area 712, and a recommendation indication L4c for displaying the ECO indication may be provided at this position. Thus, the driver can identify an indication for recommending a driving operation of high energy efficiency by making reference to the level meter during the accelerator operation and the brake operation both, so that the recognition of the recommendation indication (ECO indication) by the driver is improved.
In the above embodiments, the case where the level meter 710 extends vertically is illustrated. However, the invention is not limited to this, and if an indication recommending a deceleration can be displayed at a position corresponding to the CHG area of the hybrid system indicator, the level meter may be other meter than the meter extending vertically, for example, such as a meter extending laterally and a meter having an arc shape.

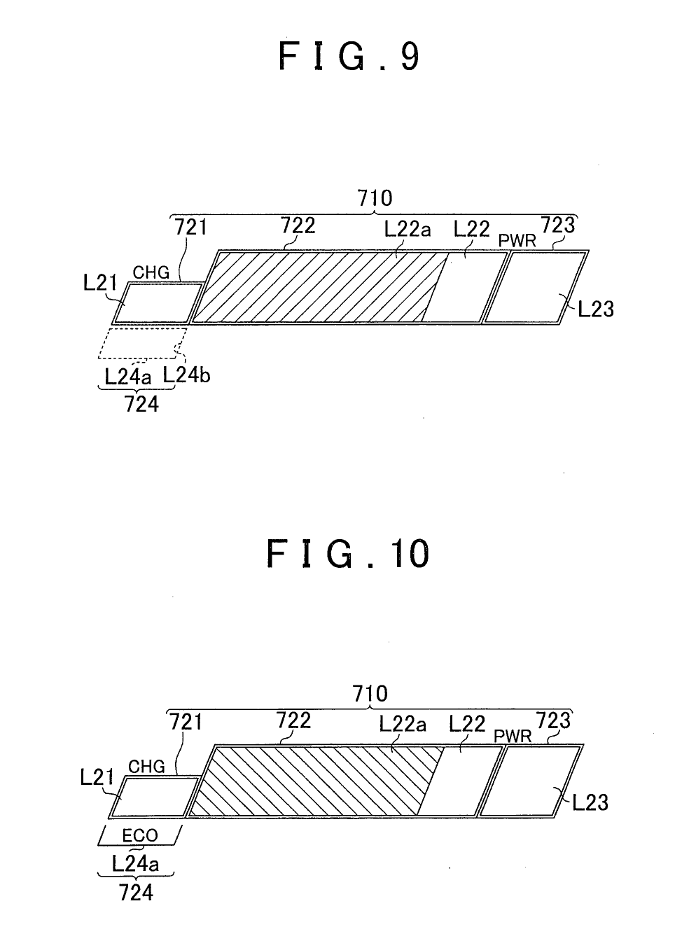

For example, as shown in FIG. 9, in a level meter 710 extending laterally, a CHG area 721, an electric motor driving area 722, and a PWR area 723 may be disposed from left to right. The CHG area 721 is provided with a lighting area L21, the electric motor driving area 722 is provided with a graph area L22 for displaying a graph L22a that extends from left to right when the output of the electric motor is increased, and the PWR area 723 is provided with a graph area L23 for displaying a graph that extends from left to right when the output of the engine is increased. Further, a recommendation display area 724 is provided at a position that is arranged under the CHG area 721 and corresponds to the CHG area 721, and the recommendation display area 724 is provided with a recommendation indication L24a.

Meanwhile, as shown in FIG. 10, when it is possible to arrive at the target position with the target speed by the deceleration that is achieved only by the regeneration operation of the electric motor (the regenerative braking), by lighting the lighting area L24b of the recommendation indication L24a to display the indication recommending the deceleration on the display unit 71, the driver may recognize the indication recommending the deceleration.

Thus, the design flexibility of the driving assist apparatus is improved. In the above embodiments, the case where the GPS apparatus 14, the driving assist apparatus 40, the vehicle navigation system 32, and the infrastructure communications apparatus 30 are mounted on the vehicle 1 is illustrated. However, the invention is not limited to this, and a portion of the functions of the GPS apparatus, the driving assist apparatus, the vehicle navigation system, and the infrastructure communications apparatus may be provided outside the vehicle. For example, a function for substituting a portion of the functions of the driving assist apparatus, a portion or all of the functions of the vehicle navigation system, the functions of the infrastructure communication apparatus, and the GPS apparatus may be provided in an external apparatus such as a portable information processing apparatus, as long as the driving assist apparatus can obtain information required from the external apparatus such as the portable information processing apparatus. Thus the configuration flexibility of the driving assist apparatus is improved.
In the above embodiments, the case where the vehicle 1 is connected with the infrastructure communication apparatus 30 and the vehicle navigation system 32 is illustrated. However, the invention is not limited to this, and if the driving assist apparatus can obtain the target position and the distance from the current position of the vehicle to the target position, at least one of the infrastructure communication apparatus and the vehicle navigation system may not be provided in the vehicle. Further, for example, it is possible to detect the traffic light, temporary stop position and so on as the target position by a sensor such as an in-vehicle camera. Thus the application range of the driving assist apparatus is expanded.
In the above embodiments, the case where the driving assist apparatus 40 is configured of the prediction unit 50, the driving assist calculation unit 60, and the vehicle display unit 70 is illustrated. However, the invention is not limited to this, and if the driving assist apparatus includes the functions of the prediction unit, the driving assist calculation unit and the vehicle display apparatus, it may be configured of a single apparatus, or may be configured of a plurality of apparatus which can exchange information with each other. Thus, the design flexibility of the driving assist apparatus is improved.
In the above embodiments, the case where the prediction unit 50 includes the learning unit 51 is illustrated. However, the invention is not limited to this, and the driving assist apparatus may not include the learning unit. Even if it is not provided with the learning unit, it is possible to provide driving assist for the target position obtained based on the road map data, the infrastructure information and so on.
In the above embodiments, the case where the distribution of the driving force is calculated by the accelerator control unit 25 and the distribution of the braking force is calculated by the brake control unit 20 is illustrated. However, the invention is limited not this, and it may be configured to perform collectively by a hybrid control apparatus, as long as the distribution of the driving force and the distribution of the braking force can be performed suitably. Thus the configuration flexibility of the driving assist apparatus is improved.
In the above second embodiment, the case where the accelerator off deceleration Db is the deceleration that is generated by the engine brake is illustrated. However, the invention is not limited to this, and the accelerator off deceleration may also be a deceleration other than the deceleration that is generated by the brake operation, for example, may be a deceleration that is generated by drive mechanisms such as wheels and gears of the vehicle. Further, a deceleration having the same degree as the engine brake may be generated by the regeneration operation of the electric motor and so on. Thus the application range of the driving assist apparatus is expanded.
In the above embodiments, the case where the regenerative braking force calculation unit 61 calculates the maximum regenerative deceleration of the electric motor 24 based on the specifications of the electric motor 24 and the power supply 23 is illustrated. However, the invention is not limited to this, and the regenerative braking force calculation unit may also calculates the maximum regenerative deceleration of the electric motor based on one of the specification of the electric motor and the specification of the power supply. Alternatively, the regenerative braking force calculation unit may calculate the maximum regenerative deceleration of the electric motor by considering one or more of the traveling speed, the remaining power storage in the battery and so on, in addition to at least one of the specification of the electric motor and the specification of the power supply. Alternatively, the regenerative braking force calculation unit may obtain the maximum regenerative deceleration of the electric motor from a preset value. Thus the assist accuracy of the driving assist apparatus may be set suitable.
In the above embodiments, the case where the prediction unit 50 predicts the target position and the target speed is illustrated. However, the invention is not limited to this, and if the target position is the stop position, the prediction unit may predict only the target speed. Thus, the applicability of the driving assist apparatus is expanded.
In the above embodiments, the case where the reaction time is 3 seconds is illustrated. However, the invention is not limited to this, and the reaction time may be longer than 3 seconds or shorter than 3 seconds. The reaction time varies depending on the driver, the driving conditions and so on, therefore it may be changed suitably to a suitable value according to the detected driver information, or may be a value determined based on the general trend. Thus the design flexibility of the driving assist apparatus is improved.
In the above embodiments, the case where the timing calculation unit 62 calculates the display switching timing P2 as the distance to the target position P0 based on the deceleration distance and the reaction distance is illustrated. However, the invention is not limited to this, and the timing calculation unit may calculate the display switching timing as the time to the target position P0. For example, the timing calculation unit may use time calculated based on the deceleration time required for the current vehicle speed V1 (50 km/h) to reduce to the target speed (0 km/h) and the reaction time from the driver recognizing the indication recommending the deceleration to performing the deceleration operation as the display switching timing. Thus the design flexibility of the driving assist apparatus is improved.
In the above embodiments, the case where the timing calculation unit 62 calculates the display switching timing P2 in order to arrive at the target speed with the target position is illustrated. However, the invention is not limited to this, and only the target speed may be specified and the target position may not be determined. For example, when performing deceleration by only obtaining the limited speed as the target speed, it is possible to display the indication recommending the deceleration even the position starting the limitation is not determined, in order to be decelerated to the limited speed only by the regeneration operation (the regenerative braking). At this time, the display switching timing may employ a timing at which information about the limited speed can be obtained. Thus the application range of the driving assist apparatus is expanded.
In the above embodiments, the case where the accelerator control unit 25 selects suitably the CD mode and the CS mode as a mode of consuming the battery is illustrated. However, the invention is not limited to this, and the accelerator control unit may have either of the CD mode and the CS mode as the mode of consuming the battery. Thus, no matter in the CD mode or the CS mode, the driving assist apparatus can provide assist information for regenerating more electric energy when the vehicle is decelerated.

In addition, there is a case of representing the CD mode that is described in the above embodiments as an EV mode, and a case of representing the CS mode as a HV mode. In the above embodiments, the case where the regenerated electric power is charged to the battery of the power supply 23 is illustrated. However, the invention is not limited to this, and the regenerated electric power may not be charged to the battery. For example, the charging may not be performed when the battery is in a state that can not be charged, and the regenerated electric power may be consumed instead of be charged or may be charged to a battery that is not used for driving. Thus the application range of the driving assist apparatus is expanded.
In the above embodiments, the case where the driving assist apparatus 40 is provided in a hybrid vehicle is illustrated. However, the invention is not limited to this, and the driving assist apparatus may be provided in an electric vehicle. The use of the mechanical brake in the electric vehicle is also be suppressed, and it is possible to increase the deceleration utilizing the regenerative operation of the electric motor (the regenerative braking). Thus the energy efficiency is improved, that is, the fuel efficiency and the power cost are improved.

1. A driving assist apparatus of performing driving assist for a vehicle which includes an electric motor for charging electric power regenerated by being mechanically driven by wheels to a power storage unit, the driving assist apparatus comprising:
an index calculation unit configured to calculate an index by which the vehicle can be decelerated only by a regeneration operation of the electric motor;
a display unit configured to display an indication that the vehicle can be decelerated only by the regeneration operation of the electric motor in a recognizable manner to a driver of the vehicle;
a prediction unit configured to predict a target position at which the vehicle is decelerated to a target speed; and
a calculation unit configured to calculate a timing at which the display unit displays the indication that the vehicle can be decelerated only by the regeneration operation, according to a distance or time required until a speed of the vehicle becomes the target speed by a deceleration that is performed based on the index, a distance or time required until the driver starts a deceleration operation, and the predicted target position.

2. The driving assist apparatus according to claim 1, wherein
the calculation unit is configure to calculate the timing as a timing at which a distance or time that is obtained by adding the distance or time required until the speed of the vehicle becomes the target speed to the distance or time required until the driver starts the deceleration operation is a distance or time to the predicted target position.

3. The driving assist apparatus according to claim 2, wherein
the prediction unit is configured to predict an intersection, a traffic signal area, or a temporary stop place as the target position.

4. The driving assist apparatus according to claim 1, wherein
the target speed is “0”.

5. The driving assist apparatus according to claim 1, wherein
the index calculation unit is configured to calculate the index as a deceleration of the vehicle when the electric power regenerated by the electric motor is maximum.

6. The driving assist apparatus according to claim 5, wherein
the index calculation unit is further configured to calculate a deceleration with which the vehicle is decelerated when the driver does not perform an acceleration or deceleration operation.

7. The driving assist apparatus according to claim 6, wherein
the calculation unit is configured to estimate a timing of switching to a state where the driver performs the acceleration or deceleration operation from a state where the driver does not perform the acceleration or deceleration operation, and calculate the timing based on the estimated timing, the deceleration with which the vehicle is decelerated when the driver does not perform the acceleration or deceleration operation, and the deceleration of the vehicle when the electric power regenerated by the electric motor is maximum.

8. The driving assist apparatus according to claim 1, wherein
the display unit is configured to display the indication that the vehicle can be decelerated only by the regeneration operation as an indication recommending the regeneration operation of the electric motor.

9. The driving assist apparatus according to claim 1, wherein
the display unit is configured to display an indication that a current operating state of the electric motor is a state of being electrically driven, and an indication that a current operating state of the electric motor is a state of being regenerating electric power,
enable the indication that the vehicle can be decelerated only by the regeneration operation to be displayed in a position corresponding to the indication that the current operating state of the electric motor is a state of being regenerating electric power.

10. A driving assist method of performing driving assist for a vehicle which includes an electric motor for charging electric power regenerated by being mechanically driven by wheels to a power storage unit, the driving assist method comprising:
calculating an index by which the vehicle can be decelerated only by a regeneration operation of the electric motor;
displaying, on a display unit, an indication that the vehicle can be decelerated only by the regeneration operation of the electric motor in a recognizable manner to a driver of the vehicle;
predicting a target position at which the vehicle is decelerated to a target speed; and
calculating a timing at which the display unit displays the indication that the vehicle can be decelerated only by the regeneration operation, according to a distance or time required until a speed of the vehicle becomes the target speed by a deceleration that is based on the index, a distance or time required until the driver starts a deceleration operation, and the predicted target position.
